(19) United States
(12) Patent Application Publication
(10) Pub. No.: US 2025/0121432 A1
(43) Pub. Date: Apr. 17, 2025

(54) COMPOSITE WEAR COMPONENT

(71) Applicant: Magotteaux International S.A., Vaux-sous-Chevremont (BE)

(72) Inventors: Stéphane DESILES, Aywaille (BE); François LEPOINT, Liège (BE); Burhan TAS, Verviers (BE)

(21) Appl. No.: 18/999,606

(22) Filed: Dec. 23, 2024

Related U.S. Application Data
(62) Division of application No. 17/491,345, filed on Sep. 30, 2021.
Application No. 17/491,345 is a continuation of application No. PCT/EP2021/057409, filed on Mar. 23, 2021.

(30) Foreign Application Priority Data
Mar. 27, 2020 (EP) 20166110.5

(51) Int. Cl. B22F 1/148; B22D 19/02; B22F 3/12

(52) U.S. Cl. CPC B22F 1/148; B22D 19/02; B22F 3/12; B22F 2201/20; B22F 2203/11; B22F 2301/35; B22F 2302/10; B22F 2304/10

(57) ABSTRACT

A hierarchical composite wear component may have a reinforcement in the most exposed part to wear, the reinforcement including a three-dimensionally interconnected network of periodically alternating millimetric ceramic-metal composite granules with millimetric interstices. The ceramic-metal composite granules have at least 52 vol %, 5 preferably at least 61 vol %, more preferably at least 70 vol % of micrometric particles of titanium carbide embedded in a first metal matrix. The ceramic-metal composite granules have a density of at least 4.8 g/cm³. The three-dimensionally interconnected network of ceramic-metal composite granules with its millimetric interstices is embedded in the second metal matrix. The reinforcement has on average at least 23 vol %, more preferably at least 28 vol %, most preferably at least 30 vol % of titanium carbide, the first metal matrix being different from the second metal matrix, the second metal matrix including a ferrous cast alloy.

### CROSS-REFERENCES

The following applications and materials are incorporated herein, in their entireties, for all purposes: International Application No. PCT/EP2021/057409, filed on Mar. 23, 2021; U.S. patent application Ser. No. 17/491,345, filed on Sep. 30, 2021. However, such material is only incorporated to the extent that no conflict exists between the incorporated material and the statements and drawings set forth herein. In the event of any such conflict, including any conflict in terminology, the present disclosure is controlling.

### FIELD

The present disclosure relates to hierarchical composite wear components obtained by cast technology.

### INTRODUCTION

Wear components are often employed in the grinding and crushing industry, such as cement factories, quarries and mines. These components are often subjected to high mechanical stresses in the bulk and to high wear by abrasion at the working faces. It is therefore desirable that these components should exhibit a high abrasion resistance and some ductility to be able to withstand the mechanical stresses such as impacts.

Given that these two properties are difficult to match with the same material composition, composite components having a core made of relatively ductile alloy in which ceramic inserts of good wear resistance are embedded have been proposed in the past.

Document U.S. Pat. No. 4,119,459 (Sandvik, 1977) discloses a composite wear body composed of cast iron and sintered cemented carbide crushed granules. The cemented carbide, in a binder metal, is of WC-Co-type with possible additions of carbides of Ti, Ta, Nb or other metals. No indication is given about the volume percentage of possible TiC in the granules or in the reinforced part of the body.

Document U.S. Pat. No. 4,626,464 (Krupp, 1984) discloses a beater which is to be installed in a hammer comprising a metal alloy basic material and a wear resistant zone containing hard metal particles in addition to a ferroalloy, the hard metal particles have a diameter of from 0.1 to 20 mm and the percentage of the hard metal particles in the wear resistant zone lies between 25 and 95 volume percent; and wherein said hard particles are firmly embedded within said metal alloy basic material. The average volume concentration of possible TiC in the reinforced part is not disclosed in this document

U.S. Pat. No. 5,066,546 (Kennametal, 1989) discloses a hierarchical wear resistant body comprising at least one layer of a series of carbide material, among which titanium carbide embedded in a casted steel matrix. The carbide material has a particle size between 4.7 and 9.5 mm wherein said carbide material is in the form of crushed parts, powder or pressed bodies having an irregular shape. This document neither discloses the average concentration of TiC in the reinforced part of the wear body nor the constitution of the reinforcing structure.

Document U.S. Pat. No. 8,999,518 B2 discloses a hierarchical composite material comprising a ferrous alloy reinforced with titanium carbide according to a defined geometry, in which said reinforced portion comprises an alternating macro-microstructure of millimetric areas that are concentrated with micrometric globular particles of titanium carbide separated by millimetric areas that are essentially free of micrometric globular particles of titanium carbide, said areas being filled by a ferrous alloy. In this patent, the maximum TiC concentration is 72.2 vol % when a powder blend of Ti and C is compacted at a maximum relative density of 95%. The porosity of the granules is higher than 5 vol % and, in absence of a possible reaction moderator, only one metal matrix, the cast metal, is present. The hierarchical composite material is obtained by self-propagating high temperature synthesis (SHS), where reaction temperatures generally above 1,500° C., or even 2,000° C., are reached. Only little energy is needed for locally initiating the reaction. Then, the reaction will spontaneously propagate to the totality of the mixture of the reagents.

The hierarchical composite of this document is obtained by the reaction in a mold of granules comprising a mixture of carbon and titanium powders. After initiation of the reaction, a reaction front develops, which thus propagates spontaneously (self-propagating) and which allows titanium carbide to be obtained from titanium and carbon. The thereby obtained titanium carbide is said to be “obtained in situ” because it is not provided from the cast ferrous alloy. This reaction is initiated by the casting heat of the cast iron or the steel used for casting the whole part, and therefore both the non-reinforced portion and the reinforced portion. The Ti→C->TiC SHS reaction is very exothermic with theoretical adiabatic temperature of 3290 K.

Unfortunately, the rise in temperature causes degassing of the reactants i.e. the volatiles contained therein (H₂O in carbon, H₂, N₂ in titanium). All impurities contained in the reactant powders, organic or inorganic components around or inside the powder/compacted grains, are volatilized. To attenuate the intensity of the reaction between the carbon and the titanium, powder of a ferrous alloy is added therein as moderator to absorb the heat and decrease the temperature. Nevertheless, this also decreases the maximum obtainable TiC concentration in the final wear part and the above-mentioned theoretical concentration of 72.2% is not attainable anymore in practice on the production scale.

Document WO 2010/031663A1 relates to a composite impactor for percussion crushers, said impactor comprising a ferroalloy which is at least partially reinforced with titanium carbide in a defined shape according to the same method than the document U.S. Pat. No. 8,999,518 B2 previously described. To attenuate the intensity of the reaction between the carbon and titanium, ferrous alloy powder is added. In an example of this document, the reinforced areas comprise a global volume percentage of about 30% of TiC. To this end, a strip of 85% relative density is obtained by compaction. After crushing the strip, the obtained granules are sieved so as to reach a dimension between 1 and 5 mm, preferably 1.5 and 4 mm. A bulk density in the range of 2 g/cm³ is obtained (45% space between the granules +15% porosity in the granules). The granules in the wear part to be reinforced thus comprise 55 vol % of porous granules. In such case, the concentration of TiC in the reinforced area is only 30% which is not always sufficient and likely to have a negative impact on the wear performance of the casting, in particular with grains of high porosity before the SHS reaction.

Document US 2018/0369905A1 discloses a method providing a more precise control of the SHS process during casting by using a moderator. The casting inserts are made from a powder mixture comprising the reactants of TiC formation and a moderator having the composition of cast high-manganese steel containing 21% Mn.

### SUMMARY

The present disclosure relates to a hierarchical composite wear component obtained by cast technology having an improved resistance to the combined wear/impact stresses. The wear component comprises a three-dimensional network of aggregated millimetric ceramic-metal composite granules with millimetric interstices wherein TiC based micrometric particles are embedded in a binder, called the first metal matrix, the millimetric interstices being filled by the cast metal, called the second metal matrix in the present disclosure.

The present invention aims to provide a hierarchical composite wear component produced by conventional casting comprising a metal matrix in cast iron or steel, integrating a reinforced structure with a high concentration of micrometric titanium carbide particles embedded in a metallic binder (first metal matrix) forming low porosity ceramic-metal composite granules. The first metallic matrix including the micrometric titanium carbide particles of the reinforced part is different from the metal matrix present in the rest of the composite wear component.

Another aim of the present invention is to provide a safe manufacturing process of reinforced composite wear parts, avoiding the release of gases, providing an improved composite wear component, with a good resistance to impacts and corrosion.

A first aspect of the present invention relates to hierarchical composite wear component comprising a reinforcement in the most exposed part to wear, the reinforcement comprising a three-dimensionally interconnected network of periodically alternating millimetric ceramic-metal composite granules with millimetric interstices, said ceramic-metal composite granules comprising at least 52 vol %, preferably at least 61 vol %, more preferably at least 70 vol % of micrometric particles of titanium carbide embedded in a first metal matrix, the ceramic-metal composite granules having a density of at least 4.8 g/cm³, the three-dimensionally interconnected network of ceramic-metal composite granules with its millimetric interstices being embedded in the second metal matrix, said reinforcement comprising in average at least 23 vol %, more preferably at least 28 vol %, most preferably at least 30 vol % of titanium carbide, the first metal matrix being different from the second metal matrix, the second metal matrix comprising the ferrous cast alloy.

According to preferred embodiments of the invention, the composite wear component is further characterized by one of the following features or by a suitable combination thereof:
the ceramic-metal composite granules have a porosity of less than 5% vol, preferably less than 3% vol, more preferably less than 2%;
the embedded ceramic-metal composite granules have an average particle size d50 between 0.5 and 10 mm, preferably 1 and 5 mm;
the embedded titanium carbide particles have an average particle size d50 between 0.1 and 50 μm, preferably 1 and 20 μm;
the first metal matrix is selected from the group consisting of ferro-based alloy, ferromanganese-based alloy, ferrochromium-based alloy and nickel-based alloy;
the second metal matrix comprises ferrous alloy, in particular high chromium white iron or steel.

The present invention further discloses a method for the manufacturing of a ceramic-metal composite granules comprising the steps of:
grinding powder compositions comprising TiC and a first metal matrix in presence of a solvent, preferably to reach an average particle size d50 between 1 and 20 μm, preferably between 1 and 10 μm;
mixing 1 to 10%, preferably 1 to 6% of wax to the powder composition;
removing the solvent by vacuum drying to obtain an agglomerated powder;
compacting the agglomerated powder into strips, sheets or rods;

crushing the strips, sheets or rods to granules, preferably of an average size d50 between 0.5 to 10 mm, preferably 1 and 5 mm;
sintering at a temperature between 1000-1600° C. in a vacuum or inert atmosphere furnace until a density of at least 4.8 g/cm³ is reached.

The present invention further discloses a method for the manufacturing of the composite wear component of the present invention comprising the following steps:
mixing the ceramic-metal composite granules obtained according to the invention with about 1 to 8 wt %, preferably 2 to 6 wt % of glue;
pouring and compacting the mix in a first mold;
drying the mix at appropriate temperature and time to remove the solvent of the glue or enable hardening;
demolding the dried mix and obtaining the three-dimensionally interconnected network of periodically alternating millimetric ceramic-metal composite granules with millimetric interstices, to be used as reinforcement in the part exposed to wear of the hierarchical wear component.

According to preferred embodiments of the invention, the method for the manufacturing of the wear component is further characterized by the following steps or by a suitable combination thereof:
positioning the three-dimensionally interconnected network of periodically alternating millimetric ceramic-metal composite granules with millimetric interstices in the part of the volume of the mold of the hierarchical composite cast wear component to be cast;
pouring a second metal matrix into a second mold, the mold of the cast wear part, and simultaneously infiltrating the millimetric interstices of the three-dimensionally interconnected network;

demolding the hierarchical composite cast wear component.

The present invention further discloses a hierarchical composite cast wear component obtained by the method of the invention.

### BRIEF DESCRIPTION OF THE DRAWINGS

FIG. 1 shows the anvil ring of a milling machine in which the tests were carried out for the present invention.

FIGS. 2 represents an individual anvil of the anvil ring of FIG. 1.

FIGS. 3 represents a worn individual anvil.

FIGS. 4 is a schematic representation of the positioning of the reinforcement structure in the most exposed part to wear of the individual anvil.

FIGS. 5 represents a global view of the reinforcement structure defined as the three-dimensionally interconnected network of periodically alternating millimetric ceramic- metal composite granules with millimetric interstices.

FIGS. 6 and 7 represent a magnification view of the reinforcement structure of FIG. 5.

FIGS. 8 represents a sectional view of the cast wear component with the millimetric ceramic-metal composite granules inclusion with interstices (voids) filled by the second metal matrix (the cast metal matrix).

FIGS. 9 represents microscopic spheroidal TiC particles embedded in the first metal matrix, the binder of the TiC particles. The picture is a high magnification of one single ceramic-metal composite grain represented in FIG. 8.

FIGS. 10 is a schematic representation of the concept of the present invention based on a scale difference between the embedded micrometric TiC particles in a first metal matrix forming millimetric granules of ceramic-metal composite integrated in the form of a three dimensional network in the reinforced part of the wear component.

FIGS. 11 is a representation of a cross section of a sample comprising granules, this cross section being used in the method to obtain the ceramic-metal granule average particle size (as explained below).

FIG. 12 is a schematic representation of the method to measure the diameter Feret (with minimum and maximum Feret diameters). These diameters of Feret being used in the method to obtain the ceramic-metal granule average particle size (as explained below).

### DETAILED DESCRIPTION

The present invention relates to a hierarchical composite wear component produced by conventional casting. It consists of a metal matrix comprising a particular reinforcement structure comprising dense (low porosity <5%) irregular ceramic-metal composite granules with millimetric size average of 0.5 to 10 mm, preferably 0.8 to 6 mm, more preferably from 1 to 4 mm, even more preferably from 1 to 3 mm.

Ceramic-metal composites are composed of ceramic particles bonded by a metallic binder, called in the present invention the first metal matrix. For wear applications, the ceramic provides the high wear resistance while the metal improves, amongst other properties, the toughness. TIC ceramic-metal composites comprise titanium carbide micrometric spheroidal particles (52 to 95 vol % of the granules, preferably 61 to 90 vol %, more preferably 70 to 90 vol %, size from 0.1 to 50 μm, preferably 0.5 to 20 μm, more preferably 1 to 10 μm) bonded by a metallic phase (first metal matrix) that can for example be Fe, Ni or Mo based. A ferrous alloy, preferably chromium cast iron or steel (second metal matrix), is cast in the mold and infiltrates only the interstices of the said reinforcement structure.

In the present invention, the expression TiC should not be understood in a strict stoichiometric chemical meaning but as Titanium Carbide in its crystallographic structure. Titanium carbide possesses a wide composition range with C/Ti stoichiometry varying from 0.47 to 1, a C/Ti stoichiometry higher than 0.8 being preferred.

The volume content of ceramic-metal composite granules in the insert building the reinforced volume of the wear part (hollows parts or recesses, if any, excluded) is typically comprised between 45 and 65 vol %, preferably between 50 and 60 vol % leading to average TiC concentrations in the reinforced volume comprised between 23 and 62 vol %, preferably between 28 and 60 vol %, more preferably between 30 and 55 vol %.

The hierarchical reinforced part of the wear component is produced from an aggregation of irregular millimetric ceramic-metal composite granules having an average size between approximately 0.5 to 10 mm, preferably 0.8 to 6 mm, more preferably from 1 to 4 mm, even more preferably from 1 to 3 mm

The ceramic-metal composite granules are preferably aggregated into a desired tridimensional shape with an adhesive (inorganic like well-known sodium (or potassium) silicate glass inorganic glues or organic glues like polyurethane or phenolic resins) or within a container or behind a barrier (usually metallic but said container or barrier could also be of ceramic nature, inorganic in general or organic). This desired shape forms an open structure formed of a three-dimensionally interconnected network of agglomerated/aggregated ceramic-metal composite granules bound by a binding agent or maintained in shape by a container or barrier, wherein the packing of the granules leaves millimetric open interstices between the granules, the millimetric interstices being fillable by a liquid cast metal. This agglomerate is placed or located in a mold prior to the pouring of the ferrous alloy to form the reinforced part of the wear component. The liquid metal is then poured into the mold and the liquid metal fills the open interstices between the granules. Millimetric interstices should be understood as interstices of 0.1 to 5 mm, preferably 0.5 to 3 mm depending on the compaction of the reinforcement structure and the size of the granules.

The ceramic-metal composite granules are usually manufactured in a conventional way, by powder metallurgy, shaping a blend of ceramic and metallic powders of appropriate size distribution followed by a liquid-phase sintering.

Typically, the powders are 0.1-50 μm in diameter and comprise TiC as the main component and 5 to 48 percent of a metallic binder which can be an individual constituent powder or already alloyed powders (first metal matrix). The powders are first mixed and/or ground (depending on the initial powder size) in a ball mill, dry or wet grinding (with alcohol to avoid the metallic powder oxidation for example). Some organic aids may be added for dispersion or shaping aid purposes. A drying step may be needed in case of wet grinding. This can be done for example by vacuum drying or spray-drying. The shaping is usually performed by cold uniaxial, isostatic pressing or injection molding or any other shaping methods to form a strip, a rod or a sheet.

Stripe of sheets, for instance, can be crushed to grains and possibly sieved. It can be an advantage to achieve irregular granule shapes free of easy pull out orientation (granules very well mechanically retained in the cast metal). The pressed, extruded or crushed granules are then sintered at a suitable temperature under low or high vacuum, inert gas, hydrogen or combinations thereof. During liquid-phase sintering, particle rearrangement occurs, driven by capillarity forces.

The cast alloy (second metal matrix) embedding the ceramic-metal composite granules of the wear component is preferably a ferrous alloy (chromium white iron, steel, manganese steel . . . ) or a Nickel or Molybdenum alloy. This alloy can be chosen in order to achieve locally optimized properties depending on the final solicitation on the wear part (for example manganese steel will provide high impact resistance, high-chromium white iron will provide higher wear resistance, nickel alloy will provide superior heat and corrosion resistance, etc.).

### Advantages

The present invention allows to obtain, within a conventional casting, a concentration of TiC particles that can be very high in the ceramic-metal composite granules (52 to 95% in volume), with no risk of defects inside the cast structure (gas holes, cracks, heterogeneities . . . ) or uncontrolled and dangerous reactions and projections as for in-situ formation of TiC in a self-propagating exothermic reaction (SHS, see above).

In the present invention, good average concentrations of TiC can be reached in the reinforced volume of the wear part, via low porosity of the ceramic-metal composite granules. Values up to about 62 vol % can be reached depending on the compaction/piling of the ceramic-metal composite granules in the reinforced volume.

The hierarchical wear component of the present invention is substantially free of porosity and cracks, resulting in better mechanical and wear properties.

The size of the particles of titanium carbide and the ceramic-metal composite granules (TiC+binder) of the present invention can be extensively controlled during the manufacturing process (choice of raw materials, grinding, shaping process and sintering conditions). Using sintered, millimetric TiC-based ceramic-metal composite granules made by well-known powder metallurgy allows the control of grain size and porosity, use of various compositions of metallic alloys as first metal matrix, high concentration of TiC, easy shaping of inserts without extensive need of man work, and good internal health of grains after the pouring even in high thermal shock conditions.

### Manufacturing of the Ceramic-Metal Composite Granules

The grinding and/or the mixing of the inorganic TiC powder (52 to 95 vol %, preferably 61 to 90 vol %, more preferably 70 to 90 vol %) and metallic powders as first metallic matrix (5 to 48 vol %, preferably 10 to 39 vol %, more preferably 10 to 30 vol %) is carried out, as mentioned above, in a ball mill with a liquid that can be water or alcohol, depending on metallic binder sensitivity to oxidation. Various additives (antioxidant, dispersing, binder, plasticizer, lubricant, wax for pressing, . . . ) can also be added for various purposes.

Once the desired average particle size is reached (usually below 20 μm, preferably below 10 μm, more preferably below 5 μm) the slurry is dried (by vacuum drying or spray drying) to achieve agglomerates of powder containing the organic aids.

The agglomerated powder is introduced in a granulation apparatus through a hopper. This machine comprises two rolls under pressure, through which the powder is passed and compacted. At the outlet, a continuous strip (sheet) of compressed material is obtained which is then crushed in order to obtain the ceramic-metal composite granules. These granules are then sifted to the desired grain size. The non-desired granule size fractions are recycled at will. The obtained granules have usually 40 to 70% relative density (depending on compaction level powder characteristics and blend composition).

It is also possible to adjust the size distribution of the granules as well as their shape to a more or less cubic or flat shape depending on the crushing method (impact crushing will deliver more cubic granules while compression crushing will give more flat granules). The obtained granules globally have a size that will provide, after sintering, granules between 0.5 to 10 mm, preferably 0.8 to 6 mm, more preferably from 1 to 4 mm, even more preferably from 1 to 3 mm. Granules can also be obtained by classical, uniaxial pressing or granulating of the powder blend directly as grains or into much bigger parts that will be further crushed into granules, before or after sintering.

Finally, liquid phase sintering can be performed in a furnace at a temperature of 1000-1600° C. for several minutes or hours, under vacuum, N₂, Ar, H₂ or mixtures, depending on the metallic phase (type and quantity of the binder) until the desired porosity is reached, preferably below 5%, more preferably less than 3%, most preferably less than 2%.

### Realization of the Three-Dimensional Reinforcement Structure (Core)

As mentioned above, the ceramic-metal composite granules are agglomerated either by means of an adhesive, or by confining them in a container or by any other means. The proportion of the adhesive does not exceed 10 wt % relative to the total weight of the granules and is preferably between 2 and 7 wt %. This adhesive may be inorganic or organic. An adhesive based on a sodium or potassium silicate or an adhesive based on polyurethane or phenolic resin can be used.

The ceramic-metal composite granules with low porosity are mixed with an adhesive, usually an inorganic silicate glue and placed into a mould (for example in silicone) of the desired shape. After glue setting (obtained at 100° C. after water drying of the inorganic silicate glue for instance, the glue setting could also be obtained by gassing with CO₂ or amine-based gas for polyurethane-based glue for example), the core is hardened and can be demoulded. Depending on granule shape, size distribution, vibration during the positioning of the granules or tapping the granules bed while making the core, the core usually comprises 30 to 70 vol %, preferably 40 to 60 vol % of dense granules and 70 to 30vol % preferably 60 to 40 vol % of voids (millimetric interstices) in a 3D interconnected network.

### Casting of the Wear Part

The core (three-dimensional reinforcement structure) is positioned and fixed with screws or any other available means in the mold portion of the wear part to be reinforced. Hot liquid ferrous alloy, preferably chromium white iron or steel, is then poured into the mold.

The hot, liquid, ferrous alloy is thus only filling the millimetric interstices between the granules of the core. If an inorganic glue is used, limited melting of the metallic binder (first metal matrix) on the granule surface induces a very strong bonding between the granules and the second matrix alloy. When using an organic glue comprising sodium silicate, the metallic bonding is limited but can still occur on the granule surfaces that are not covered by the glue.

Contrary to the state of the art, there is no reaction (exothermic reaction or gas release) or shrinkage (volume contraction of 24% for the Ti+C→TiC reaction) during the pouring, and the cast metal will infiltrate the interstices (millimetric spaces between the granules) but will not infiltrate the ceramic-metal composite granules since they are not porous.

### Measurement Methods

For porosity, granule or particle size measurements, a sample is prepared for metallographic examination, which is free from grinding and polishing marks. Care must be taken to avoid tearing out of particles that can lead to a misleading evaluation of porosity. Guidelines for the specimen preparation can be found in ISO 4499-1:2020 and ISO 4499-3:2016, 8.1 and 8.2.

### Porosity Determination

The volume fraction of porosity of the free granules can be calculated from the measured density and the theoretical density of the granules.

The volume fraction of porosity of the granule embedded in the metal matrix is measured according to ISO 13383-2:2012. Although this standard is applied specifically to fine ceramics, the described method to measure the volume fraction of porosity can also be applied to other materials. As the samples here are not pure fine ceramics but hard metals composites, sample preparation should be done according to ISO 4499-1:2020 and ISO 4499-3:2016, 8.1 and 8.2. Etching is not necessary for porosity measurement but can be performed anyway as it will not change the result of measurement.

### Titanium Carbide Average Particle Size

The average particles size of the embedded titanium carbide particles is calculated by the linear-intercept method according to ISO 4499-3:2016. Five images from the microstructure of five different granules are taken with an optical or electronic microscope at a known magnification such that there are 10 to 20 titanium carbide particles across the field of view. Four linear-intercept lines are drawn across each calibrated image so that no individual particle is crossed more than once by a line. Where a line intercepts a particle of titanium carbide, the length of the line (Iᵢ) is measured using a calibrated rule (where i=1,2,3 . . . n for the 1^{st}, 2^{nd}, 3^{rd}, . . . , nth grains). Incomplete particles touching the edges of the image must be ignored. At least 200 particles must be counted.

The mean-linear-intercept particle size is defined as:

$${d}_{x} = \frac{\sum {i}_{i}}{n}$$

### Ceramic-Metal Granule Average Particle Size

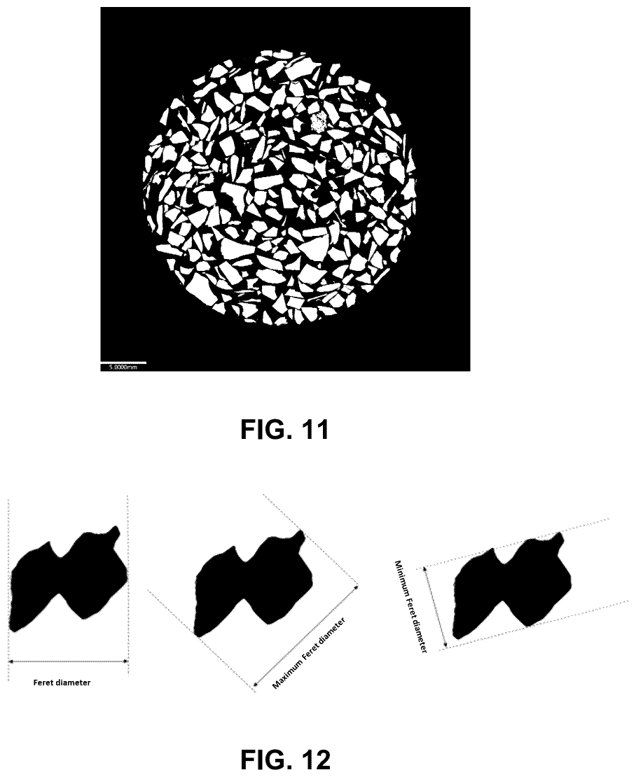

A photomicrographic panorama, such that there are at least 250 ceramic-metal granules across the field of view, of the polished cross section of the sample, is made by stitching (the process of combining a series of digital images of different parts of a subject into a panoramic view of the whole subject that retains good definition) using a computer program and optical microscope (for example a general image field panorama obtained by an Alicona Infinite Focus). An appropriate thresholding allows the segmentation of grayscale image into features of interest (the granules) and background (see FIG. 11). If the thresholding is inconsistent due to poor image quality, a manual stage involving drawing by hand the granules, the scale bar if present and the image border on a tracing paper and then scanning the tracing paper is used.

Feret diameter, which is the distance between two tangents placed perpendicular to the measuring direction, is measured in all direction for each granule by an image analysis software (ImageJ for example). An example is given in FIG. 12.

Minimum and maximum Feret diameter of each granule of the image are determined. Minimum Feret diameter is the shortest Feret diameter out of the measured set of Feret diameters. Maximum Feret diameter is the longest Feret diameter out of the measured set of Feret diameters. Granules touching the edges of the image must be ignored. The mean value of the minimum and maximum Ferret diameters of each granule is taken as the equivalent diameter x. The volume size distribution q₃(x) of the granules is then calculated based on spheres of diameter x.

D₅₀ of the granules is to be understood as the volume weighted mean size x_{1̅,3} according to ISO 9276-2:2014 .

### Ceramic-Metal Granule Average Particle Size During Manufacturing of the Granules

Granules size is measured by dynamic image analysis according to ISO 13322-2:2006 by the mean of a Camsizer from Retsch. The particle diameter used for size distribution is X_{c min}, which is the shortest chord measured in the set of maximum chords of a particle projection (for a result close to screening/sieving).

Granule d₅₀ is the volume weighted mean size of the volume distribution based on X_{c min}.

### Particle Size Measurement of the Powder During the Grinding

The particle size of the powder during the grinding is measured by laser diffraction with the MIE theory according to guidelines given in ISO 13320:2020 by the mean of a Mastersizer 2000 from Malvern. Refractive index for TiC is set to 3 and the absorption to 1. Obscuration must be in the range 10 to 15% and the weighted residual must be less than 1%.

### Density Measurement of the Sintered Granules

The determination of the density of sintered granules is performed with water according to ISO 3369:2006. For granules without any open porosity, a gas displacement pycnometer (like the AccuPyc II 1345 Pycnometer from Micromeritics) can also be used, giving substantially the same density value.

### Reduction to Practice—Anvil Wear Part

Anvil wear parts used in a vertical shaft impactor have been realized according to the invention. The reinforced volume of the wear parts comprises different average volume percentages of TiC from about 30 up to 50 vol %.

They were compared to a wear part made according to U.S. Pat. No. 8,999,518 B2, example 4 of the inventor (with a global volume percentage of TiC of about 32 vol % in the reinforced volume).

The reason for this comparison is that example 4 is a typical “in-situ” composition (Ti+C and moderator in a self-propagating reaction) that can be managed with care in plants in spite of the fact that it is still creating lots of flames, gases and hot liquid metal projection during the pouring.

### EXAMPLES

### Granule Preparation

The following raw materials were used for 3 different types of ceramic-metal composite granule:
TiC powder less than 325 mesh
Iron powder less than 325 mesh
Manganese powder less than 325 mesh
Nickel powder less than 325 mesh

TABLE 1

| Composition (wt %) | Example 1 | Example 2 | Example 3 |
|---|---|---|---|
| TiC | 45.0 | 65.0 | 85.0 |
| Fe | 44.8 | 28.5 | 12.2 |
| Mn | 7.7 | 4.9 | 2.1 |
| Ni | 2.5 | 1.6 | 0.7 |
| Total | 100.0 | 100.0 | 100.0 |
| Theoretical sintered density | 6.22 | 5.68 | 5.22 |

Powders according to the compositions of table 1 have been mixed and ground in a ball mill with alcohol and metallic balls for 24 h to reach an average particle size of 3 μm.

An organic wax binder, 4 wt % of powder, is added and mixed with the powder. The alcohol is removed by a vacuum-dryer with rotating blades (the alcohol being condensed to be re-used). The agglomerated powder obtained is then sifted through a 100 μm sieve. Strips of 60% of the theoretical density of the inorganic/metallic powder mixtures are made by compaction between the rotating rolls of a roller compactor granulator. The strips are then crushed to irregular granules by forcing them through a sieve with appropriate mesh size. After crushing, the granules are sifted so as to obtain a dimension between 1.4 and 4 mm. These irregular porous granules are then sintered at high temperature (1000-1600° C. for several minutes or hours) in a vacuum furnace with low partial pressure of argon until a minimal porosity (<5 vol %) and a density higher than 5 g/cm³ are reached.

The sintered granules with low porosity<5 vol % are then mixed with about 4 wt % of an inorganic silicate glue and poured into a silicone mold (vibrations can be applied to ease the packing and be sure that all the granules are correctly packed) of the desired shape of 100×30×150 mm. After drying at 100° C. for several hours in a stove to remove water from the silicate glue, the cores are hard enough and can be demolded.

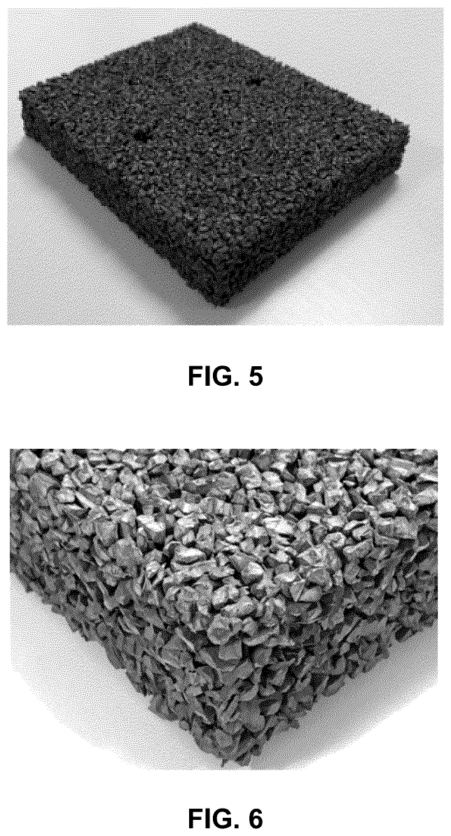

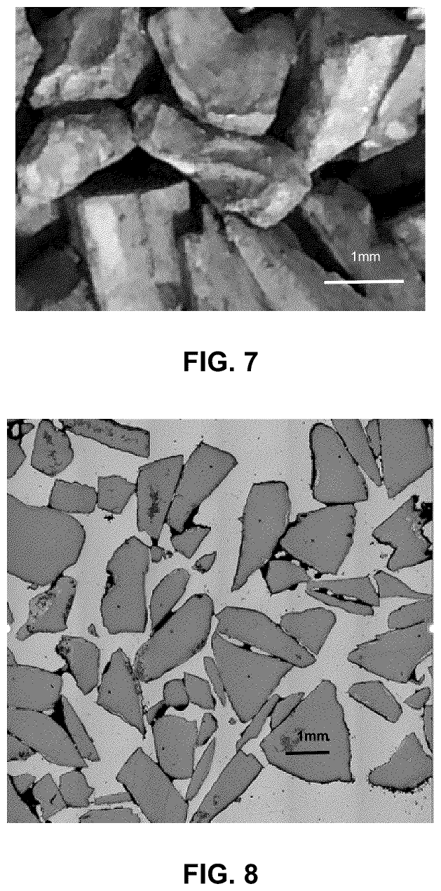

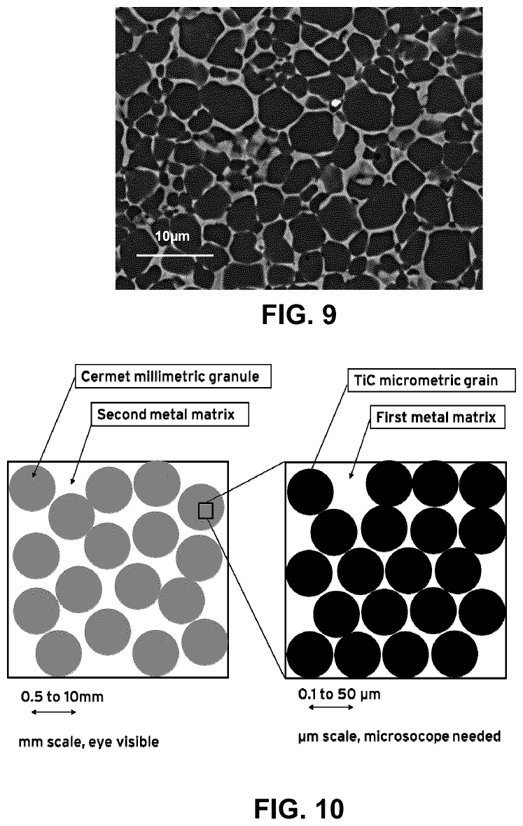

These cores, as represented in FIG. 5, comprise about 55 vol % of dense granules (45 vol % of voids/millimetric interstices between the granules). Each cores/three dimensional reinforcement structures are positioned in the molds in the portion of the wear parts to be reinforced (as represented in FIG. 4). Hot liquid high-chromium white iron is then poured into the molds. The hot, liquid, high-chromium white iron is thus filling about 45 vol % of millimetric interstices between the granules of the core. After pouring, in the reinforced portion, 55 vol % of areas with a high concentration of about 57 vol % to 90 vol % of titanium carbide particles bonded by a different metal phase (first metal matrix) than in the rest of the wear part, where the cast alloy (second metal matrix) is present, are obtained. The global volume content of TiC in the reinforced macro-microstructure of the wear part varies in examples 1 to 3 from about 32 to 50 vol %, but even higher values can be reached.

### Comparison with Prior Art

The wear parts according to the invention are compared to the wear part obtained analogously to example 4 of U.S. Pat. No. 8,999,518 B2.

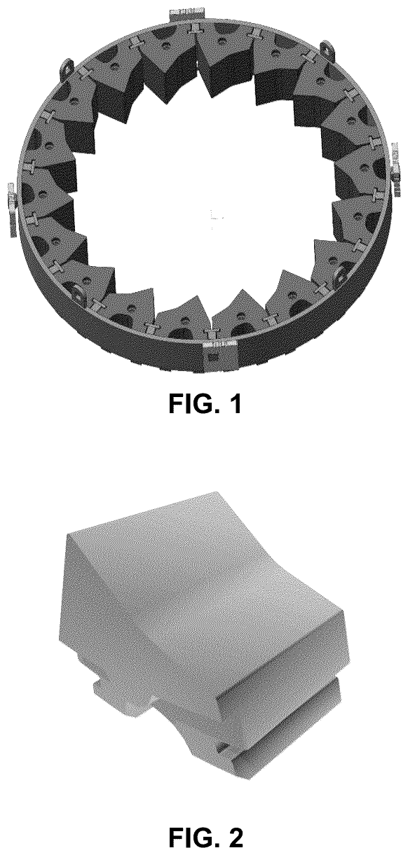

The anvil ring of the milling machine in which these tests were carried out is illustrated in FIG. 1.

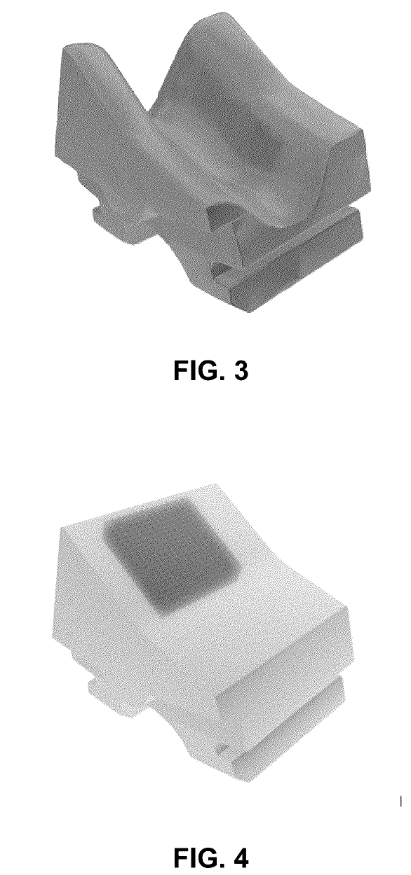

In this machine, the inventor alternately placed an anvil comprising an insert (as represented in FIGS. 2 and 3) according to the present invention surrounded on either side by a reinforced anvil according to the state of the art U.S. Pat. No. 8,999,518 B2, example 4 to evaluate the wear under exactly the same conditions.

Material to be crushed is projected at high speed onto the working face of the anvils (an individual anvil before wear is represented in FIG. 2). During crushing, the working face is worn. The worn anvil is represented in FIG. 3.

For each anvil, the weight loss is measured by weighting each anvil before and after use.

weight loss=(final weight−initial weight)/initial weight

A performance index is defined as below, the weight loss of reference being the average weight loss of U.S. Pat. No. 8,999,518 B2, example 4, anvil on each side of the test anvil.

PI=weight loss of reference/weight loss of test anvil

Performance index above 1 means that the test anvil is less worn than the reference, below 1 means that the test anvil is more worn than the reference.
Performance index (PI) of the reinforced anvil according to example 1 of this invention (ceramic-metal composite grains containing 57 vol % by (45 wt %) of Titanium carbide): 1.05 (higher performance of ceramic-metal composite grains with local volume content close to US 8,999,518 B2, example 4 can be explained by lower defects like cracks and porosity in the part)
Performance index (PI) of the reinforced anvil according to example 2 of this invention (ceramic-metal composite grains containing 75 vol % (65 wt %) of Titanium carbide): 1.16
Performance index (PI) of the reinforced anvil according to example 3 of this invention (ceramic-metal composite grains containing 90 vol % (85 wt %) of Titanium carbide): 1.24

TABLE 2

| | 1.4 to 4 mm granules | example 1 | example 2 | example 3 | example 4 |
|---|---|---|---|---|---|
| before | Granules relative density (%) | 99.8% | 99.6% | 99.7% | 85.0% |
| pouring | Granules porosity (%) | 0.2% | 0.4% | 0.3% | 15.0% |
| | Quantity (g) | 1579 | 1356 | 1289 | 900 |
| | Density of the granules (g/cm³) | 6.19 | 5.65 | 5.21 | 4.25 |
| | Dimensions of the reinforced area (mm) | 150 × 100 × 30 | 150 × 100 × 30 | 150 × 100 × 30 | 150 × 100 × 30 |
| | Volume of the reinforced area (cm³) | 450 | 450 | 450 | 450 |
| | Filling of the reinforced portion of the part | 57% | 54% | 55% | 55% |
| | (vol %) | | | | |
| | Volume of granules (cm³) | 255 | 241 | 248 | 249 |
| after | Final TiC content in the granules (vol %) | 57% | 74% | 90% | 57% |
| pouring | Final TiC content in the reinforced portion | 32% | 40% | 50% | 32% |
| | (vol %) | | | | |
| | Porosity in the reinforced area (% vol) | <0.5 | <0.5 | <0.5 | 3.00 |
| | Performance Index | 1.05 | 1.16 | 1.24 | 1.00 |

### Composite Density as a Function of Porosity and Density of the Compounds (Titanium Carbide and Alloys)

Below are two tables with the density of the composite as a function of % vol of TIC and % vol of porosity (for iron and nickel based alloys).

TABLE 3

| | density (g/cm³) |
|---|---|
| Titanium carbide | 4.93 |
| Ferrous alloy | 7.87 |
| Nickel alloy | 8.91 |

TABLE 4

| Composite density | | porosity (vol %) | | | |
|---|---|---|---|---|---|
| with ferrous alloy (g/cm³) | | 5% | 3% | 2% | 0.10% |
| Titanium carbide | 52% | 6.02 | 6.15 | 6.21 | 6.33 |
| content (vol %) | 61% | 5.77 | 5.89 | 5.96 | 6.07 |
| | 70% | 5.52 | 5.64 | 5.70 | 5.81 |
| | 85% | 5.10 | 5.21 | 5.26 | 5.37 |
| | 96% | 4.80 | 4.90 | 4.95 | 5.04 |
| | 99% | 4.71 | 4.81 | 4.86 | 4.95 |

TABLE 5

| Composite density | | porosity (vol %) | | | |
|---|---|---|---|---|---|
| with nickel alloy (g/cm³) | | 5% | 3% | 2% | 0.10% |
| Titanium carbide | 52% | 6.50 | 6.64 | 6.70 | 6.83 |
| content (vol %) | 61% | 6.16 | 6.29 | 6.35 | 6.48 |
| | 70% | 5.82 | 5.94 | 6.00 | 6.12 |
| | 85% | 5.25 | 5.36 | 5.42 | 5.52 |
| | 96% | 4.83 | 4.94 | 4.99 | 5.08 |
| | 99% | 4.72 | 4.82 | 4.87 | 4.96 |

### Advantages

The present invention has the following advantages in comparison with the state of the art in general:
Better wear performance due to locally higher vol % of TiC in the granules (impossible to reach in practice with SHS technologies of the state of the art)
Better wear performance or mechanical properties of the wear part by tailoring the size and volume content of titanium carbide and use of a metal phase binder (first metal matrix) such as for example high mechanical properties manganese steel in the TiC ceramic-metal composite granules combined to the cast alloy (second metal matrix) such as for example high chromium white iron for the wear part, the first metal matrix being different from the second metal matrix.
Better wear performance or mechanical properties of the wear part due to lower porosity and/or lower crack defects at all since no gas is generated during pouring, and the TiC dispersion is homogeneous.
Better safety during manufacturing since no dangerous exothermic reaction with flammable gases release or fused liquid metal projection during pouring will occur.
Better safety during manufacturing due to handling of less dangerous raw materials to make the granules (Fe powder is a less exposable powder than Ti which is highly exposable powder).

### Illustrative Combinations and Additional Examples

This section describes additional aspects and features of the present disclosure, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A hierarchical composite wear component comprising a reinforcement in the most exposed part to wear, the reinforcement comprising a three-dimensionally interconnected network of periodically alternating millimetric ceramic-metal composite granules with millimetric interstices, said ceramic-metal composite granules comprising at least 52 vol %, preferably at least 61 vol %, more preferably at least 70 vol % of micrometric particles of titanium carbide embedded in a first metal matrix, the ceramic-metal composite granules having a density of at least 4.8 g/cm³, the three-dimensionally interconnected network of ceramic-metal composite granules with its millimetric interstices being embedded in the second metal matrix, said reinforcement comprising in average at least 23 vol %, more preferably at least 28 vol %, most preferably at least 30 vol % of titanium carbide, the first metal matrix being different from the second metal matrix, the second metal matrix comprising the ferrous cast alloy.
A1. The hierarchical composite cast wear component according to A0, wherein the ceramic-metal composite granules have a porosity of less than 5 vol %, preferably less than 3 vol %, more preferably less than 2 vol %.
A2. The hierarchical composite cast wear component according to A0 or A1,wherein the embedded ceramic-metal composite granules have an average particle size d50 between 0.5 and 10 mm, preferably 1 and 5 mm.
A3. The hierarchical composite cast wear component according to any one of A0 through A2, wherein the embedded titanium carbide particles have an average particle size d50 between 0.1 and 50 μm, preferably 1 and 20 μm.
A4. The hierarchical composite cast wear component according to any one of paragraphs A0 through A3, wherein the first metal matrix is selected from the group consisting of ferro-based alloy, ferromanganese-based alloy, ferrochromium-based alloy and nickel-based alloy.
A5. The hierarchical composite cast wear component according to any one of paragraphs A0 through A4, wherein the second metal matrix comprises high chromium white iron or steel.
B0. A method for the manufacturing of the ceramic-metal composite granules of any one of paragraphs A0 through A5, comprising the steps of:
grinding powder compositions comprising TiC and the first metal matrix in presence of a solvent;
1 mixing 1 to 10%, preferably 1 to 6% of wax to the powder composition;
removing the solvent by vacuum drying to obtain an agglomerated powder;
compacting the agglomerated powder into strips, sheets or rods;
crushing the strips, sheets or rods to granules;
sintering at a temperature between 1000-1600° C. in a vacuum or inert atmosphere furnace until a density of at least 4.8 g/cm³ is reached.
B1. The method according to B0, wherein the step of grinding powder compositions comprising TiC and the first metal matrix in presence of a solvent is performed until an average particle size d50 between 1 and 20 μm, preferably between 1 and 10 μm is obtained.
B2. The method according to B0 or B1, wherein the granules crushed from strips, sheets or rods have an average particle size d₅₀ between 0,5 and 10 mm, preferably between 1 and 5 mm.
C0. A method for the manufacturing of the three-dimensionally interconnected network of periodically alternating millimetric ceramic-metal composite granules with millimetric interstices comprising the steps of:
mixing the ceramic-metal composite granules obtained according to B0 with about 1 to 8 wt %, preferably 2 to 6 wt % of glue;
pouring and compacting the mix in a first mold;
drying the mix at appropriate temperature and time to remove the solvent of the glue or enable hardening;
demolding the dried mix and obtaining the three-dimensionally interconnected network of periodically alternating millimetric ceramic-metal composite granules with millimetric interstices, to be used as reinforcement in the part exposed to wear of the hierarchical wear component.
D0. A method for the manufacturing of the three-dimensionally interconnected network of periodically alternating millimetric ceramic-metal composite granules with millimetric interstices according to A0, comprising the following steps:
positioning the three-dimensionally interconnected network of periodically alternating millimetric ceramic-metal composite granules with millimetric interstices in the part of the volume of the mold of the hierarchical composite cast wear component to be cast;
pouring a second metal matrix into a second mold, the mold of the cast wear part, and simultaneously infiltrating the millimetric interstices of the three-dimensionally interconnected network;
demolding the hierarchical composite cast wear component.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method for manufacturing a cast wear component having a reinforced portion, the method comprising:
preparing a casting mold to cast a wear component;
positioning a reinforcement structure in a portion of the casting mold, wherein the reinforcement structure comprises a three-dimensionally interconnected network of alternating ceramic-metal composite granules and interstices;
pouring a metal matrix into the casting mold such that the metal matrix infiltrates the interstices of the reinforcement structure; and
demolding the wear component.

2. The method of claim 1, further comprising fixing the reinforcement structure at a location of the casting mold corresponding to the portion of the wear component to be reinforced with one or more fasteners prior to pouring the metal matrix into the casting mold.

3. The method of claim 1, wherein the granules of the reinforcement structure have a porosity of less than 5 Vol %.

4. The method of claim 1, wherein the metal matrix is a first metal matrix, and wherein the granules comprise at least 52 vol % of particles of titanium carbide embedded in a second metal matrix.

5. The method of claim 4, wherein a composition of the first metal matrix is different from a composition of the second metal matrix.

6. The method of claim 5, wherein the composition of the first metal matrix comprises a ferrous cast alloy.

7. The method of claim 1, wherein the three-dimensionally interconnected network of the reinforced portion has a thickness of 30 mm or more.

8. The method of claim 1, wherein the granules have an average size between 0.5 mm and 10 mm.

9. The method of claim 1, wherein the reinforcement structure comprises 45 to 65 vol % of ceramic-metal composite granules.

10. A method for manufacturing a reinforcement structure for a cast wear component, the reinforcement structure comprising a three-dimensionally interconnected network of alternating granules and interstices, the method comprising:
preparing a reinforcement structure mold;
mixing a plurality of ceramic-metal composite granules with a quantity of adhesive, wherein the quantity of adhesive is no greater than 10 wt % relative to a total weight of the granules;
arranging the mix of granules and adhesive in the reinforcement structure mold;
setting the adhesive to fix the granules into a three-dimensionally interconnected network of alternating granules and interstices; and
demolding the reinforcement structure.

11. The method of claim 10, wherein the adhesive is selected from the group consisting of inorganic silicate glue, polyurethane resin and phenolic resin.

12. The method of claim 10, wherein setting the adhesive comprises drying the mix of granules and adhesive at a temperature configured to set the adhesive.

13. The method of claim 10, wherein arranging the mix of granules and adhesive in the reinforcement structure mold comprises pouring and compacting the mix of granules and adhesive into the reinforcement structure mold such that the granules fill 45 to 65 vol % of the reinforcement structure mold.

14. The method of claim 10, wherein arranging the mix of granules and adhesive in the reinforcement structure mold comprises pouring and compacting the mix of granules and adhesive into the reinforcement structure mold such that the network has a thickness of 30 mm or more.

15. The method of claim 10, wherein the interstices of the network are sufficiently large to be infiltrated by a liquid metal poured in a casting mold when the reinforcement structure is disposed in the casting mold.

16. A method for manufacturing ceramic-metal composite granules, the method comprising:
grinding a powder composition comprising titanium carbide and a metal matrix in the presence of a solvent;
removing the solvent by vacuum drying, thereby obtaining an agglomerated powder;
compacting the agglomerated powder into strips, sheets, or rods;
crushing the strips, sheets, or rods into granules; and
sintering the granules to a density of at least 4.8 g/cm³.

17. The method of claim 16, further comprising mixing a wax into the powder composition, the wax comprising 1 to 10 wt % of the powder composition.

18. The method of claim 16, wherein grinding the powder composition comprises grinding the powder composition such that an average powder particle size d₅₀ is between 1 and 20 μm.

19. The method of claim 16, wherein crushing the strips, sheets, or rods into granules comprises crushing the strips, sheets, or rods such that the granules have an average size d₅₀ between 0.5 and 10 mm.
